(19) United States
(12) Patent Application Publication
(10) Pub. No.: US 2024/0201065 A1
(43) Pub. Date: Jun. 20, 2024

(54) NANOPARTICLE SIZE AND ELEMENTAL COMPOSITION CHARACTERIZATION

(71) Applicant: Texas Tech University System, Lubbock, TX (US)

(72) Inventor: Gerardo Gamez, Lubbock, TX (US)

(73) Assignee: Texas Tech University System, Lubbock, TX (US)

(21) Appl. No.: 18/541,426

(22) Filed: Dec. 15, 2023

Related U.S. Application Data
(60) Provisional application No. 63/432,911, filed on Dec. 15, 2022.

(51) Int. Cl. G01N 15/1429; G01N 15/02

(52) U.S. Cl. CPC G01N 15/1429; G01N 15/02

(57) ABSTRACT

Embodiments of the present disclosure pertain to methods of identifying one or more characteristics of particles by (1) placing the particles on a surface; (2) exposing the particles to an ion to result in emissions from the particles; (3) measuring the emissions from the particles; (4) generating an emission profile from the measured emissions; and (5) correlating the generated emission profile to one or more characteristics of the particles

### CROSS-REFERENCE TO RELATED APPLICATIONS

This application claims priority to U.S. Provisional Patent Application No. 63/432,911, filed on Dec. 15, 2022. The entirety of the aforementioned application is incorporated herein by reference.

### STATEMENT REGARDING FEDERALLY SPONSORED RESEARCH

This invention was made with government support under CHE-2108359, awarded by the National Science Foundation. The government has certain rights in the invention.

### BACKGROUND

A need exists for more effective systems and methods for characterizing particles. Numerous embodiments of the present disclosure aim to address the aforementioned need.

### SUMMARY

In some embodiments, the present disclosure pertains to methods of identifying one or more characteristics of particles. In some embodiments, the methods of the present disclosure include: (1) placing the particles on a surface; (2) exposing the particles to an ion to result in emissions from the particles; (3) measuring the emissions from the particles; (4) generating an emission profile from the measured emissions; and (5) correlating the generated emission profile to one or more characteristics of the particles

### DESCRIPTION OF THE DRAWINGS

FIG. 1A illustrates a method of characterizing particles in accordance with various embodiments of the present disclosure.

FIG. 1B illustrates particle size and content characterization in accordance with various embodiments of the present disclosure.

FIGS. 1C-1D show the cross-section of a glow discharge cell design (FIG. 1C) and a petrographic microscope slide interface (FIG. 1D) that are suitable for characterizing particles in accordance with various embodiments of the present disclosure.

FIG. 2A shows glow discharge optical emission spectroscopy elemental mapping (GDOES EM) at 338.28 nm (Ag I) of 3 replicate 400 ng deposits of 40 nm citrate functionalized silver (Ag) nanoparticles (NPs) on a copper (Cu) plate.

FIG. 2B shows a temporal profile of the signal intensity averaged within the region-of-interest (ROI) in FIG. 2A. The last 50 images were taken as background for background equivalent concentration (BEC) calculations.

FIG. 2C shows BEC normalized to a deposit area, as a function of the plasma gas pressure and applied RF power.

FIGS. 3A-3L show a single 1.25 μL sample, 25 ng total of 40 nm citrate Ag nanoparticles (NPs), drop-casted per deposit on Cu substrate, as observed by optical microscopy. FIGS. 3A-C and 3E-3F show scanning electron microscopy (SEM) images at different magnifications, which were measured by GDOES EM using a slit-less imaging spectrograph (MIS) mode at 338 nm wavelength (FIG. 3D, Ag I). Five 0.25 μL replicate samples, 25 ng total of 40 nm citrate functionalized Ag NPs, drop-casted per deposit on Cu substrate, were also observed by optical microscopy (FIG. 3G), SEM at different magnifications (FIGS. 3H-I and 3K-3L), and measured by GDOES EM using MIS mode at 338 nm wavelength (FIG. 3J, Ag I). Note the differences in the scale bars between FIGS. 3A, 3B, 3D vs FIGS. 3G, 3H, and 3J.

FIGS. 4A-4C show calibration curves for the GDOES EM NP deposit ROI average peak intensity (20×20 pixel binning, showed for 3 replicate 25 ng deposits) normalized to the VDC vs NP mass for Citrate 40 nm Ag NPs (FIG. 4A) and PVP 50 nm Ag NPs (FIG. 4B). Error bars: standard deviation of 9 replicate measurements. FIG. 4C shows the SEM of the full 25 ng PVP deposit (left) and the center (right).

FIGS. 5A-5C show the optical emission intensity time profiles of 25 ng deposits of PVP Ag NPs and citrate Au NPs (FIG. 5A), calibration plots of time profiles of full width at half maximum (FWHM) or FW75% M and peak time vs PVP Ag NP deposit (d.) (FIG. 5B), as well as 25 ng deposits of citrate Ag NPs at a small NP d. range (FIG. 5C, left panel) and large NP d. range (FIG. 5C, right panel). X-error bars: standard deviations from manufacturers' certificate of analysis. Y-error bars: standard deviation for 9 replicate measurements. Note the difference in the plasma pulses/image between the citrate Ag NPs sizing plots.

FIGS. 6A-6F show the optical emission intensity time profiles of 50 ng Ag core/SiO₂ shell NPs, including 90 nm total d., Ag core (x̅=47 nm, σ=5 nm) (FIG. 6A), 140 nm total d., Ag core (x̅=92 nm, σ=12 nm) (FIG. 6B), and SEM images of the 90 nm total d. deposit before sputtering/pristine, and after sputtering to the Ag I peak time (FIG. 6C). FIGS. 6D-6E show a Histogram of NP core size distribution from SEM images (overlap is shown in purple) (FIG. 6D) and corresponding Poisson fits (FIG. 6E). FIG. 6F shows GDOES EM images at various times along the time profile for both Si I (251 nm) and Ag I (328.1 nm).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose.

Due to the intensified use of NPs in many different industries, NPs are being found with greater prevalence in many environmental systems. In particular, NPs have been gaining increased interest in the last few decades due to their unique properties compared to their bulk material counterparts, which has resulted in their use for a wide variety of applications.

The chemical composition, size, shape, charge, and surface functionalization of NPs have all been known to change their unique physical and chemical properties. For instance, silver (Ag) NPs are one of the greatest contributors to this increasing prevalence, as they are one of the most marketable nanomaterials currently in use with applications ranging from textile production, agriculture, and improved food storage to the biomedical and pharmaceutical fields because of their well-known antimicrobial properties.

NP characterization methods are important to ensure that NP applications are safe and effective. For instance, the toxicity of NPs in the environment is not currently well-understood, part of which can be attributed to the lack of high-throughput, widely available, and cost-effective characterization techniques for monitoring their characteristic properties from the production stage to their integration with the environment.

There are currently a variety of techniques available for the chemical identification or characterization of NPs. However, few techniques can yield both elemental composition and size characteristics. Moreover, while the characterization techniques all have their own unique advantages and disadvantages, typical methods of choice are limited in sample throughput.

For instance, some techniques allow elemental mapping (EM), such as electron microscopy and x-ray techniques, to study NP distribution in systems of interest. However, such systems in turn bring more sample throughput limitations and may require hours to tens of hours for mapping large surface areas (e.g., ≥100 cm²).

Some EM X-ray techniques for NP characterization are able to circumvent the long acquisition-time requirements through the use of synchrotron radiation. However, such sources are not widely available, which also results in limited sample throughput.

Thus, alternative higher-throughput techniques are becoming available that can provide NP composition and size information. One such technique is single particle inductively coupled plasma mass spectrometry (sp-ICP-MS), which has the capability to measure particle size and particle number concentrations (PNC). However, size determinations by sp-ICP-MS are constrained by single particle mass detection limits. Moreover, sp-ICP-MS has several disadvantages, such as significantly more involved sample preparation for complex matrices, requirements for PNC below certain thresholds, operating conditions only optimum to certain NP type/solution matrix combination, assumptions on particle shape, and difficulty analyzing elements with higher background (e.g. O, H, C). Furthermore, EM is not inherent to sp-ICP-MS. Rather, EM is only available when coupled with laser ablation sampling, with its corresponding low sample throughput for large scale maps.

More recently, a graphite furnace atomic absorption spectroscopy method was also demonstrated for composition and sizing of Au NPs between 2 nm-100 nm from suspensions. However, such spectroscopy methods also lack EM capabilities.

As such, a need exists for more effective systems and methods for characterizing particles, such as NPs. Numerous embodiments of the present disclosure aim to address the aforementioned need.

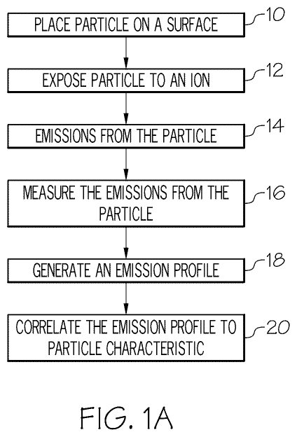

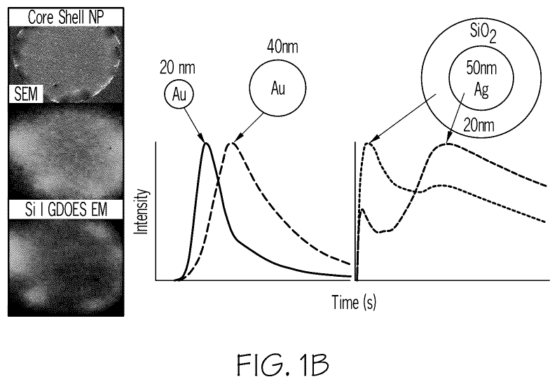

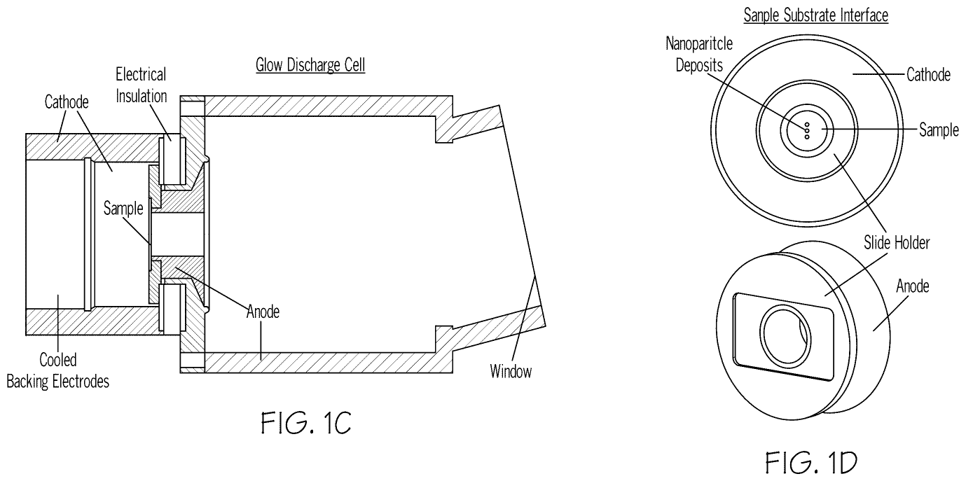

In some embodiments, the present disclosure pertains to methods of identifying one or more characteristics of particles. In some embodiments illustrated in FIG. 1A, the methods of the present disclosure include: placing the particles on a surface (step 10); exposing the particles to an ion (step 12) to result in emissions from the particles (step 14); measuring the emissions from the particles (step 16); generating an emission profile from the measured emissions (step 18); and correlating the generated emission profile to one or more characteristics of the particles (step 20). As set forth in more detail herein, the methods of the present disclosure can have numerous embodiments.

### Particles

The methods of the present disclosure may be utilized to evaluate various particles. For instance, in some embodiments, the particles to be evaluated include, without limitation, metallic particles, metallic oxide particles, nanoparticles, nitride particles, quantum dots, core- and shell-containing particles, magnetic particles, polymeric particles, metal-organic frameworks, carbon dots, nanocrystals, or combinations thereof.

In some embodiments, the particles to be evaluated include metallic oxide particles. In some embodiments, the metallic oxide particles include a metallic core and an oxide shell. In some embodiments, the metallic core includes a silver (Ag) core. In some embodiments, the oxide shell includes a silicon dioxide (SiO₂) shell.

In some embodiments, the particles include nanoparticles. In some embodiments, the nanoparticles include a size distribution ranging from 1 nm to 100 nm. In some embodiments, the nanoparticles include a size distribution ranging from 5 nm to 100 nm.

The particles of the present disclosure may be embedded in another material during evaluation. For instance, in some embodiments, the particles of the present disclosure may be embedded in a biological material, such as a plant leaf, an extracellular matrix, a tissue, a cell culture, or a blood sample.

### Placement of Particles on a Surface

Various methods may be utilized to place particles on a surface. For instance, in some embodiments, the placement includes drop casting particles onto the surface. In some embodiments, the placement includes spin coating particles onto the surface. In some embodiments, the placement includes dip coating particles onto the surface. In some embodiments, the placement includes printing particles onto the surface (e.g., through micro-droplet printing approaches). In some embodiments, the placement includes spraying particles onto the surface. In some embodiments, the placement includes the formation of an array of particles on the surface. In some embodiments, the placement includes growing the particles on the surface. In some embodiments, the placement forms a particle suspension on the surface. In some embodiments, the placement forms a thin film of particles on the surface.

The particles of the present disclosure may be placed on various surfaces. For instance, in some embodiments, the surface includes, without limitation, a non-metallic surface, a metallic-based surface, a copper-based surface, a titanium-based surface, an aluminum-based surface, an aluminum oxide-based surface, a nickel-based surface, a metal oxide-based surface, a semi-conductor surface, a silicon-based surface (e.g., a silicon wafer), or combinations thereof. In some embodiments, the surface is a titanium-based surface. In some embodiments, the surface is a non-metallic surface. In some embodiments, the surface is a component of a chamber of a glow discharge optical emission spectroscopy elemental mapping (GDOES EM) device.

### Exposure of Particles to Ions

The particles of the present disclosure may be exposed to ions in various manners. For instance, in some embodiments, the exposure of particles to ions occurs continuously as a function of time. In some embodiments, the exposure of particles to ions occurs by a method that includes, without limitation, ion beam sputtering, atom beam sputtering, fast atom bombardment, pulsed power ion beam sputtering, ion bean sputter deposition, radio frequency ion beam sputtering, cathodic sputtering, or combinations thereof.

The exposure of particles to ions can have various effects. For instance, in some embodiments, the exposure of particles to ions gradually ablates particle layers to result in emissions from different layers of the particles.

The exposure of particles to ions can occur under various conditions. For instance, in some embodiments, the exposure of particles to ions occurs under inert conditions. In some embodiments, the exposure of the particles to ions occurs under vacuum. In some embodiments, the exposure of particles to ions occurs in a chamber of a glow discharge optical emission spectroscopy elemental mapping (GDOES EM) device.

The particles of the present disclosure may be exposed to various ions. For instance, in some embodiments, the ions are in the form of plasma. In some embodiments, the ions are in the form of glow discharge plasma. In some embodiments, the ions are in the form of a partially ionized gas. In some embodiments, the ions are in the form of an ion beam. In some embodiments, the ions are in the form of an atom beam. In some embodiments, the ions include argon, neon, helium, hydrogen oxygen, or combinations thereof. In some embodiments, the ions include argon. In some embodiments, the argon is associated with one or more additional gases, such as neon, helium, hydrogen oxygen, or combinations thereof. In some embodiments, the ions are in the form of argon plasma gas.

Emissions from Particles

The exposure of particles to ions can result in various emissions from the particles. For instance, in some embodiments, the emissions from the particles represent emissions from particle elements, atoms, ions, or combinations thereof. In some embodiments, the emissions from the particles represent emissions from different particle layers

Without being bound by theory, emissions from particles can occur in various manners. For instance, in some embodiments, particles that are exposed to ions (e.g., glow discharge plasma) may undergo sputtering (e.g., bombardment with atoms and ions from the plasma to eject atoms and/or ions from the particles). Thereafter, the ejected atoms and ions may flow into the ion source (e.g., plasma) where they are excited (e.g., by collisions with electrons or energetic atoms or ions) and thereby emit measurable emissions (e.g., light).

Various methods may be utilized to measure emissions from particles. For instance, in some embodiments, the emissions from the particles are measured by emission spectroscopy. In some embodiments, the emissions from the particles are measured by glow discharge optical emission spectroscopy (GDOES). In some embodiments, the emissions from the particles are measured continuously as a function of time.

### Generated Emission Profile

The methods of the present disclosure may generate various emission profiles from measured particle emissions. For instance, in some embodiments, the generated emission profile represents emissions from particles as a function of time.

In some embodiments, the generated emission profile includes an emission pattern as a function of time. In some embodiments, the generated emission profile includes emission changes as a function of time. In some embodiments, the generated emission profile includes optical emission changes as a function of time. In some embodiments, the generated emission profile includes emission intensities as a function of time. In some embodiments, the generated emission profile includes emission peak intensity as a function of time. In some embodiments, the generated emission profile includes a peak delay time. In some embodiments, the generated emission profile includes an emission profile peak intensity time. In some embodiments, the generated emission profile includes an average pixel intensity.

### Correlation of Emission Profiles to Particle Characteristics

The methods of the present disclosure can be utilized to correlate generated emission profiles to various particle characteristics. For instance, in some embodiments, the particle characteristics include, without limitation, particle mass, particle elemental composition, particle size, particle shape, particle spatial distribution, or combinations thereof.

In some embodiments, the correlated particle characteristics include particle size. In some embodiments, the particle size is characterized by particle dimensions. In some embodiments, the particle size is characterized by particle size distribution. In some embodiments, particle size distribution ranges from about 1 nm to about 100 nm. In some embodiments, particle size distribution ranges from about 5 nm to about 100 nm.

In some embodiments, the correlated particle characteristics include particle elemental composition. In some embodiments, particle elemental composition includes metal content, non-metal content, oxygen content, hydrogen content, carbon content, nitrogen content, or combinations thereof. In some embodiments, the particle elemental composition includes particle elemental composition of different layers of the particles.

In some embodiments, the correlated particle characteristic includes particle spatial distribution. In some embodiments, particle spatial distribution is characterized by the spatial position of particles on a surface.

The methods of the present disclosure can correlate generated emission profiles to particle characteristics in various manners. For instance, in some embodiments, the correlation of the generated emission profile to particle characteristics is qualitative. In some embodiments, the correlation of the generated emission profile to particle characteristics is quantitative.

In some embodiments, the correlation of the generated emission profile to particle characteristics includes comparing the generated emission profile from the particles to emission profiles of particles that have been correlated to particle characteristics. In some embodiments, the correlation of the generated emission profile to particle characteristics includes comparing the generated emission profile from the particles to a calibration curve that represents one or more particle characteristics. In some embodiments, the correlation of the generated emission profile to particle characteristics includes comparing the generated emission profile from the particles to measured particle sputtering rates that represent one or more particle characteristics. In some embodiments, the correlation of the generated emission profile to particle characteristics includes feeding the generated emission profile from the particles into an algorithm that implements the correlation.

In some embodiments, the correlation of the generated emission profile to particle characteristics includes correlating a peak delay time of the generated emission profile to particle size. In some embodiments, the correlation of the generated emission profile to particle characteristics includes correlating a peak delay time of the generated emission profile to particle size distribution. In some embodiments, the correlation of the generated emission profile to particle characteristics includes correlating a peak intensity of the generated emission profile to particle mass.

In some embodiments, the correlation of the generated emission profile to particle characteristics includes correlating optical emission changes of the generated emission profile as a function of time to particle elemental composition. In some embodiments, the correlation of the generated emission profile to particle characteristics includes correlating optical emission changes of the generated emission profile as a function of time to particle size. In some embodiments, the correlation of the generated emission profile to particle characteristics includes correlating optical emission changes of the generated emission profile as a function of time to internal dimensions.

### Advantages and Applications

The methods of the present disclosure provide numerous advantages. For instance, in some embodiments, the methods of the present disclosure allow for the use of glow discharge optical emission spectroscopy elemental mapping (GDOES EM) in any operation mode to characterize particles in terms of mass, elemental composition, and size/structure dimensions.

In some embodiments, the methods of the present disclosure feature advantages of fast and facile sample preparation, cost-effectiveness, and analysis times within tens of seconds, which is orders of magnitude faster than competing techniques. For instance, in some embodiments, the methods of the present disclosure occur in less than 60 seconds. In some embodiments, the methods of the present disclosure occur in less than 30 seconds. In some embodiments, the methods of the present disclosure occur in less than 15 seconds. In some embodiments, the methods of the present disclosure occur in less than 10 seconds.

Additionally, in some embodiments, the methods of the present disclosure require limited amounts of particles for analysis. For instance, in some embodiments, the methods of the present disclosure require pg levels of particles for analysis.

As such, the methods of the present disclosure can find numerous applications. For instance, in some embodiments, the methods of the present disclosure may be utilized to differentiate the size distribution of nanoparticles (e.g., FIG. 1B). In some embodiments, the methods of the present disclosure may be utilized to differentiate between different types of nanoparticles (e.g., silver and gold nanoparticles). In some embodiments, the methods of the present disclosure may be utilized to identify the internal dimensions of complex core-shell nanoparticles (e.g., FIG. 1B).

### ADDITIONAL EMBODIMENTS

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1. High-Throughput Nanoparticle Characterization Via Glow Discharge Optical Emission Spectroscopy Elemental Mapping

Glow discharge optical emission spectroscopy elemental mapping (GDOES EM) can provide large area maps directly, and cost-effectively, from solid samples within tens of seconds. In this Example, GDOES EM is demonstrated for the first time for nanoparticle (NP) characterization in terms of mass, elemental composition, and size/structure dimensions. The effect of GD pulsed-power, pressure, and sample substrate were studied and optimized conditions resulted in limits-of-detection at single pg levels. While this is not at the level of single nanoparticle sensitivity, size differentiation of Ag and Au nanoparticles was successfully demonstrated between 5-100 nm, while the internal dimensions of complex core-shell NP were also identified through the optical emission changes as a function of time.

### Example 1.1. GDOES EM

Glow discharge optical emission spectroscopy (GDOES) is a high-throughput solid-sampling simultaneous multi-elemental analysis technique that requires little-to-no sample preparation and offers multi-matrix calibration schemes. GDOES also allows the analysis of light elements (O, H, C, N) where most other techniques fail. Furthermore, GDOES EM has been realized through the implementation of pulsed-power schemes while maintaining the discharge at higher-than-typical pressures. Under these conditions, the sputtered atom mixing in the discharge before emission can occur is minimized, thus preserving the lateral information with resolution of about 100 μm.

Moreover, GDOES EM is cost effective and several orders-of-magnitude faster than the EM techniques based on ion- or photon-beam rastering. Additionally, inherent access to depth resolution coupled to the fast sputtering rates permits 3-dimensional (spatial) elemental information in rapid time-frames while having the ability to measure analytes in relatively complex matrices.

In this Example, GDOES EM is demonstrated for the first time for the high-throughput detection and characterization of metallic NPs from dried-droplet residue arrays. The effect of the GDOES EM operating conditions and sample preparation were studied, and optimized conditions used for determination of the elemental composition limit-of-detection (LOD). Furthermore, the shape of the intensity time profiles is used to show the novel ability to perform NP composition and size, as well as core-shell dimensions, characterization via GDOES EM.

### Example 1.2. Glow Discharge

The Grimm-type GD chamber used in this Example was modified from a version described previously. Briefly, the Ar plasma-gas is not evacuated through the cathode anode gap, and the entire sample (cathode) is under vacuum, in contrast to the typical Grimm design. The chamber was further adapted to permit mounting and characterization of petrographic microscope-slide type substrates (27 mm×46 mm, 1.2 mm thickness) and the schematic is shown in FIGS. 1C and 1D.

A brass restricting anode assembly was designed to reduce the 40 mm i.d. to 19 mm i.d., (20 mm o.d.) and extend its length toward the cathode to maintain a gap of ˜100 μm. A MACOR slide interface electrically isolates the anode from the cathode and was designed to accept the microscope slides. A brass backing electrode was used directly for conductive substrates. In the case of nonconductive substrates, a Cu plate (12.2 mm×40.2 mm) imbedded in a PTFE plate was used to minimize arcing to the backing electrode, which is observed in this particular GD cell design.

The pressure was maintained with a gauge (MKS, Series 910), vacuum pump (Leybold, TRIVAC D-25-B) and a mass flow controller (MKS, Type 1197A Mass-Flo®) at an Ar flow rate of 0.05 slpm. A 13.56 MHz RF generator (Dressler, Cesar 1350) was used to deliver RF pulses at 1 kHz and 5% or 12.5% duty cycle. The RF power was tuned via impedance matching (Dressler, VM-5000-W) prior to each measurement and kept constant.

### Example 1.3. Imaging System

A push-broom hyperspectral imaging (PbHSI) system was adapted to perform as an imaging spectrograph. Briefly, the light from the GD is demagnified ˜1.9× by a triplet UV-VIS achromat lens. An iris (field stop) was added at the focal point of the collection lens for blocking stray light originating outside the region-of-interest, resulting in an effective f-number of 14.3 for the imaging system. Then a pair of triplet UV-VIS achromat lenses collimate and refocus the image with a 90° turning mirror placed in between to steer the light into the entrance slit of the spectrograph. The entrance slit width was set to 1.5 mm to obtain (x, y, and A) information simultaneously, while preventing the need to scan in any dimension. This allows the highest imaging duty cycle without detrimental loss of the rapidly transient signal. An 1800 lines/mm grating was selected for most studies to give a spectral window of ˜16 nm (linear dispersion of 1.2 nm/mm) except the Ag core-silica shell characterizations.

A series of images was collected until the analyte was completely sputtered and no emission was observed. Each image integrated 100 GD pulses, or 10 GD pulses for select experiments, together on chip (IOC) at a frame readout of 4.78 Hz. The iCCD camera (Andor, iSTAR 334T) gate was delayed 17 us, with either 45 us or 120 us gate width, to acquire data after 5 us from the onset of RF pulse, at 2×2 pixel binning. GDOES EM time profiles are representative of the time necessary to collect each image, without readout time.

### Example 1.4. Sample Preparation

All dilutions were performed with DI water. Standard NP solutions were obtained from nanoComposix, where x̅=average d. and σ=1 standard deviation; polyvinylpyrrolidone (PVP) Ag NPs: (x̅=9.7 nm, σ=2.1 nm), (x̅=51 nm, σ=9 nm), (x̅=74.1 nm, σ=8.2 nm); Ag core silica shell NPs: (x̅=82, σ=5 nm), (x̅=126, σ=12 nm); and citrate Ag NPs: (x̅=5.4, σ=0.8 nm). The citrate Ag NPs: (x̅=10, σ=4 nm), (x̅=20, σ=4 nm), (x̅=40, σ=4 nm), (x̅=100, σ=8) and citrate Au NPs: (x̅=20, σ=3 nm), (x̅=40, σ=4 nm), (x̅=100, σ=8) were all obtained from Sigma-Aldrich.

Core-shell NP stock solutions came suspended in ethanol while all others were in DI water. Suspensions were shaken ˜30 s when removed from refrigerator and ˜15s prior to being drop casted manually with a volumetric pipette into three dried deposits (˜2 mm d., separated by ˜1.5 mm edge-to-edge) distributed along a vertical line, which were aligned along the spectrograph's 13 mm slit height to permit simultaneous imaging without scanning.

### Example 1.5. Pressure, Power, and Substrate Studies

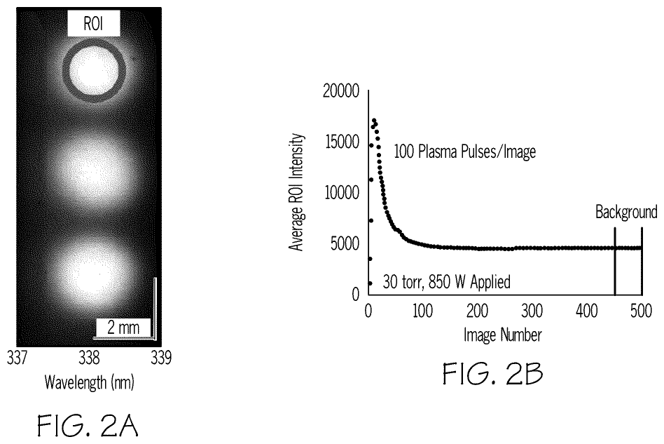

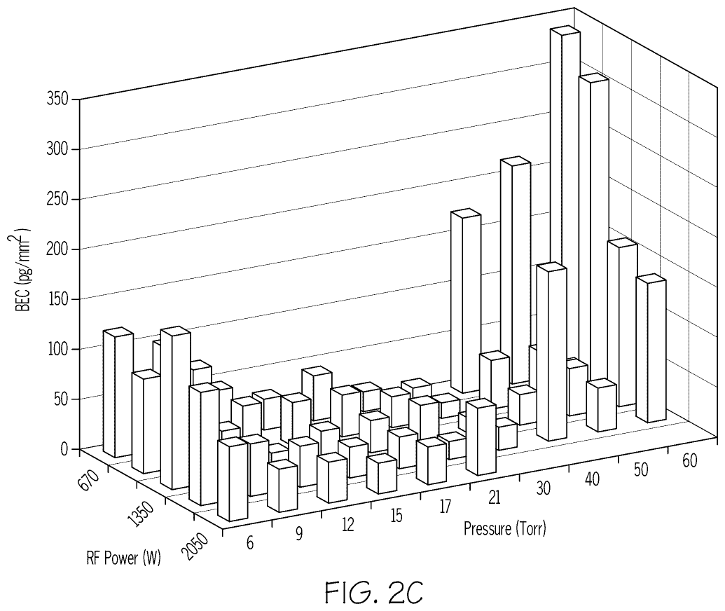

Deposits of 20 μL 40 nm Ag NPs in citrate buffer at a concentration of 20 ng/μL were drop-casted in 1 μL intervals (20×) and allowed to dry between depositions. Excessive spreading was observed on glass slides due to wetting and was restricted through the use of homemade vinyl sticker “masks”. These masks had an array of holes to provide wells where the NP suspension droplets were confined into 2 mm d. deposits during the drying step, and were removed prior to analysis. This protocol was also used for the Cu substrates to facilitate BEC comparisons with the glass (FIG. 2C).

A dichroic filter (Andover Corp, 337FS03-25, transmission of 24.4% at 338.3 nm) was placed after the collimation lens to enable use of the iCCDs full dynamic range by minimizing the stronger wavelength bands. The iCCD gate width was 45 μs with a plasma pulse width of 50 μs at 1 kHz pulse frequency. The RF power was tuned into the Cu substrates via impedance matching at each pressure and had a high coupling efficiency to the Ag NPs at the 400 ng deposited mass without using longer plasma pulse widths. 1 image=100 plasma pulse IOC.

Averaged time traces were created using ImageJ and defining a circular ROI with an edge threshold equal to 50% of the spectrally subtracted peak height. The ROI was then averaged over all pixels within this area to give an average intensity value as a function of time. The intensity values of 3-replicate deposits on one substrate were then averaged together to provide an averaged time trace. BEC's were calculated using the peak height as the signal and the last 50 images (where no Ag signal was observed) of each averaged time trace were used to obtain the mean and standard deviation of the background. LODs were calculated using 3× the standard deviation of the y intercept divided by the slope.

### Example 1.6. Limit of Detection Determination

The vinyl mask protocol was not implemented to prevent any potential loss of NPs that may be deposited on the edges of the vinyl. The dichroic filter was also removed to provide higher signal-to-noise (S/N) ratios since the filter rejects about 75% of light at the Ag I wavelength.

The 40 nm citrate functionalized Ag NPs were used with 5 replicate volume deposits of 0.25 μL each (1.25 μL total) at decreasing concentrations, 20 ng/uL 0.16 ng/uL, resulting in a mass of 25 ng-200 pg for each final dried sample. The 50 nm PVP functionalized Ag NPs were prepared the same way as the citrate, with the addition of a 0.04 ng/uL suspension which results in a 50 pg dried sample for the lowest mass. The iCCD gate width was 120 μs with a corresponding plasma pulse width of 125 μs at 1 kHz pulse frequency. The RF power was tuned via impedance matching at every mass and was necessary due to lower coupling efficiency at lower masses. 1 image=100 plasma pulses IOC.

Nine deposits (3 slides) were averaged together for statistics. The images were binned 5×5 in software, resulting in an image with 10×10 binning total. The 4 highest intensity pixels were then chosen as the ROI for averaging the signal which corresponded to an actual deposit area of 494×494 μm after the image magnification is taken into account. The PNC (per unit area) at various masses for both citrate and PVP functionalized Ag NPs were then counted manually in each SEM image (Center and Edge of ROI) and averaged together to extrapolate the mass of NPs in the ROI (Table 1).

TABLE 1
Comparison of total deposited mass vs. the mass found in the ROI. PNC was calculated
using SEM images and ImageJ. The total area used to calculate the PNC was 18.9 μm²
and 9.45 μm² for the citrate Ag NPs and PVP Ag NPs respectively.

| | 40 nm Ag | | | 50 nm Ag | | |
|---|---|---|---|---|---|---|
| | Citrate | | | PVP | | |
| | Sample 1 | Sample 2 | Sample 3 | Sample 4 | Sample 5 | Sample 6 |
| Total Deposited | 25,000 | 2,000 | 200 | 25,000 | 2,000 | 50 |
| Mass (pg) | | | | | | |
| PNC in SEM | 99 | 7 | 1 | 200 | 46 | 2 |
| (Center of ROI) | | | | | | |
| PNC in SEM | 158 | 14 | 3 | 473 | 62 | 3 |
| (Edge of ROI) | | | | | | |
| Calculated | 560 | 40 | 7 | 5,720 | 460 | 20 |
| Mass in ROI | | | | | | |
| (pg) | | | | | | |

A linear calibration curve was created between the total deposited mass and ROI mass, with the SEM mass corrected values used for the calibration curves. LODs were calculated using 3× the standard deviation of the y-intercept divided by the slope. The LOD error reported was propagated from the standard deviation of the slope.

### Example 1.7. Nanoparticle Size Characterization

The size determination experiments for both PVP and citrate functionalized Ag or Au NPs used 5 replicate volume deposits at 0.25 μL each (20 ng/μL concentration) to result in a total mass of 25 ng (1.25 μL) deposited for all the d. (5-100 nm). The iCCD/plasma conditions and the data analysis procedure were the same as for the LOD determination studies. For the PVP Ag NP sizing studies, the larger masses of the citrate Ag NPs (20-100 nm), and the Au NPs 100 plasma pulses were integrated on-chip for a single image. In the case of the smaller sized citrate Ag NPs (5-20 nm), 10 plasma pulses integrated on-chip for a single image. An intensity time trace created 9 replicate measurements (3 substrates with 3 deposits each) and were performed to obtain the FWHM/FW75% M and peak time statistics. Time traces were filtered in time using MATLAB with the function “sgolayfilt” using a 3rd order polynomial with a 11-pixel (image) window.

### Example 1.8. Silver Core/Silica Shell Nanoparticle Characterization

The characterization of the Ag core silica shell NPs used 5 replicate volume deposits at 5 μL each (20 ng/μL concentration) to result in a total mass of 50 ng (2.5 μL) for both sizes. The Ag I (328 nm) and Si I (251.6 nm) emission were monitored simultaneously using the 300 lines/mm grating, resulting in a spectral window of ˜130 nm at a linear dispersion of 9.8 nm/mm. The iCCD gate width was 120 μs with a corresponding plasma pulse width of 125 μs (12.5% duty cycle @ 1 kHz pulse frequency). The silica shells of both the 90 nm and 140 nm d. NPs had 20 nm thick shells and the core sizes were 50 nm and 100 nm, respectively.

The ROI for each core-shell image was selected at the edges of each deposit and the high spatial resolution provided by the GDOES EM images allows discrimination of emission signals where emission time profiles that align temporally and have similar peak intensities. These characteristics are indicative of regions where the particle density and sputtering rate is similar. Nine of these time traces (3 substrates with 3 deposits each) are then chosen to average together. Time traces were filtered in time using MATLAB with the function “sgolayfilt” using a 3rd order polynomial with an 11-pixel (image) window.

The SEM images (pristine vs sputtered 15 s) were analyzed in Image J using the “analyze particles” function. Parameters used were: “Auto Local Threshold” with Method “Niblack” and a 15-pixel radius, Size “100-750 pixels”, a circularity of “0.35-1”, and “include holes”. The data obtained was then used in Matlab with the function “histogram” and “normalization” was set to “probability” to plot size distributions. The “histfit” function was then used to fit Poisson distributions to the individual histograms and obtain lambda and standard deviation values.

### Example 1.9. Effect of GD Pressure and Power

The GDOES spectral image at 338.28 nm under EM conditions (FIG. 2A) shows the discrete emission from each Ag NP deposit. The average pixel intensity from the region-of-interest (ROI) changes from image-to-image, as a function of time, showing a peak at image ˜8 and decreases to a plateau as the sample is consumed by sputtering (FIG. 2B). The effect of the GD applied power and gas pressure on the Ag I emission was assessed by calculating the background equivalent concentration (BEC=(0.01×k×RSDB×C0)×SBR-1), which serves as an indicator of the LOD, where k=3, RSDB is the relative standard deviation of the background, C0 is the deposit total mass of silver, and SBR is the peak signal-to-background ratio. The BEC here is also normalized to the deposit area to account for the signal intensities spread over the iCCD pixels. It is evident that the BEC considerably improves (decreases) from 6 Torr up to 30 Torr.

The lateral resolution in GDOES EM is known to improve at higher pressures but signal intensities typically decrease. Thus, the unexpected BEC improvement trend observed here, resulting from comparable corresponding improvements in peak S/B and RSDB, is significantly advantageous.

Without being bound by theory, the trend is hypothesized to be caused by a lateral plasma confinement effect (PCE) on the NP deposit due to the higher sputtering rate of NPs vs the bulk substrate material on which they are deposited. The PCE will become more significant at higher pressures due to the plasma constriction that takes place from an increasingly lower mean free path. The PCE will not only lead to higher power density at the NP deposit but also higher lateral resolution, which will result in higher analyte signal and lower background from the bulk substrate, thus yielding lower LODs. Furthermore, the BEC becomes worse (increases) as the pressure is further increased from 30 Torr to 60 Torr (FIG. 2C) due to instability of the plasma. Applicant notes that this is the first time GDOES EM is demonstrated above 12 Torr for quantitative purposes. In addition, the BEC generally improves as the RF power is increased. The optimum conditions at 30 Torr and 850 W applied power (WA) were subsequently used for the rest of this Example.

### Example 1.10. Effect of Substrate Material

The effect of the bulk substrate composition on the figures-of-merit was also studied. Particular attention was paid to the substrate's relative sputtering rate (RSR), since it would potentially affect the hypothesized PCE. As such, glass petrographic slides, characterized by a low RSR as a thick non-conductive substrate, were tested.

While the BEC here followed a similar pressure trend as the Cu plate substrate, the pressure could not be raised ≥15 Torr due to arcing issues arising from the whole non-conductive substrate being entirely in vacuum. Lateral resolution is much better at 30 Torr vs 12 Torr, so only conductive substrates were further investigated.

However, the typical Grimm GDOES sample mount should prevent such issues and will be tested in the future. The effect of conductive substrate RSR on the LOD of Ag NPs were evaluated via mass calibration curves. Evidently, as the substrate RSR decreases, so does the corresponding LOD (Table 2).

TABLE 2
Relative sputtering rates of metallic substrates and
corresponding LODs from mass-calibration curves.

| | Cu | Ni | Ti |
|---|---|---|---|
| RSR Mean | 3.5 | 1.5 | 0.43 |
| Full Deposit LOD (pg) | 674 | 412 | 134 |

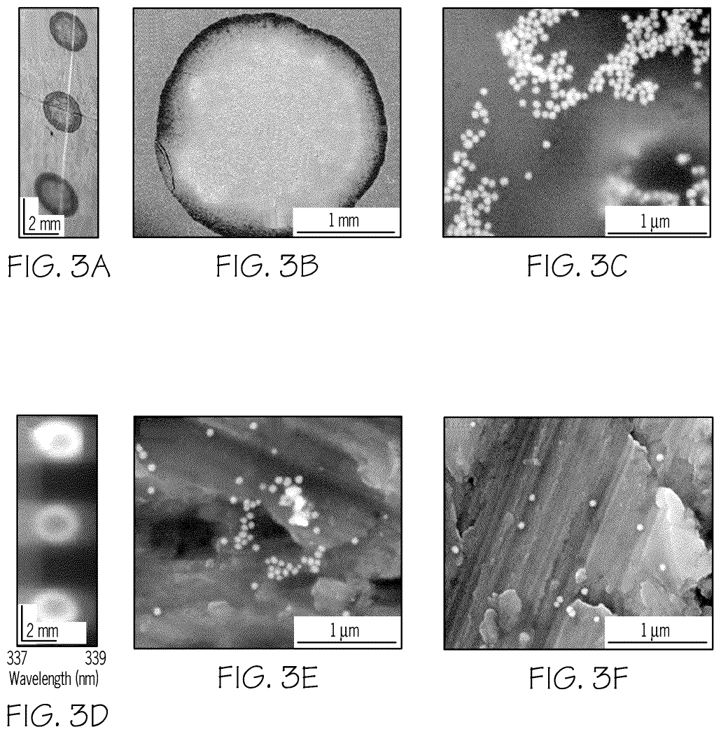

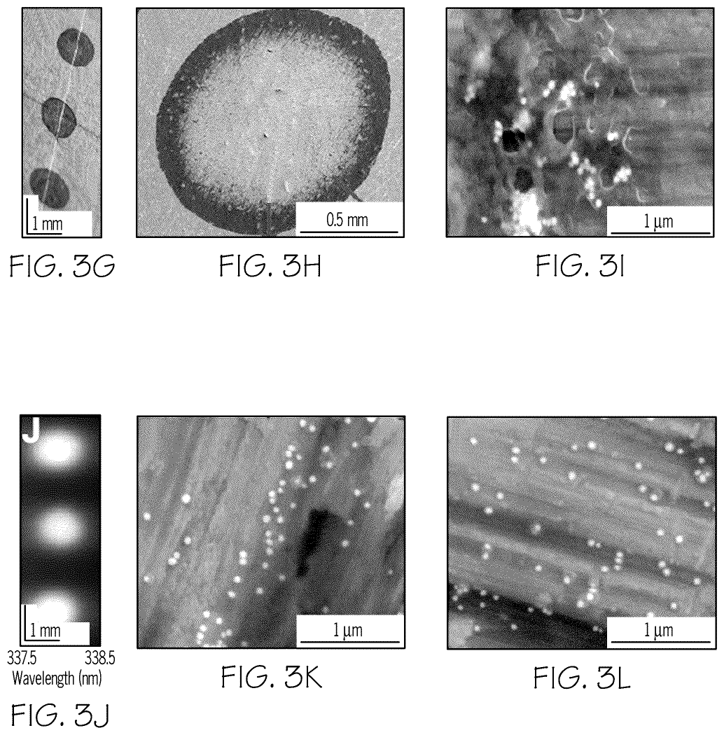

These results support the proposed PCE, because the higher NP/substrate RSR contrast would enhance plasma confinement. The simple drop-casting NP deposition method was also optimized. Drop-casting is known to produce a distinct “coffee-ring” stain of higher particle density at the perimeter, which is clearly observed here for the single-drop deposition protocol (1×1.25 μL) images under the optical (FIG. 3A) and electron microscopes (FIG. 3B). The spatial resolution of GDOES EM (FIG. 3D) also allows one to clearly observe this effect. In addition, SEM shows how the PNC significantly increases from the center of the deposit outwards (FIGS. 3C and 3E-3F). The “coffee ring” effect was minimized here by implementing a drop-casting technique with five replicate deposit volumes (5×0.25 μL). The five-drop technique allowed not only a more homogenous NP distribution over the deposit, but also to deposit the same mass onto a significantly smaller area, ˜4× (c.f. FIGS. 3A-3B and 2D vs FIGS. 3G-3H and 3J, note different scale). The SEM identifies a much thicker ring (c.f. FIGS. 3B and 3H) and increased PNC towards the center of the deposit in comparison to the single-drop deposit (c.f. FIGS. 3E-3F and 3K-3L). The higher mass/area in the five-drop method, which was used for the rest of this Example, will also result in better SNR.

### Example 1.11. Limit of Detection

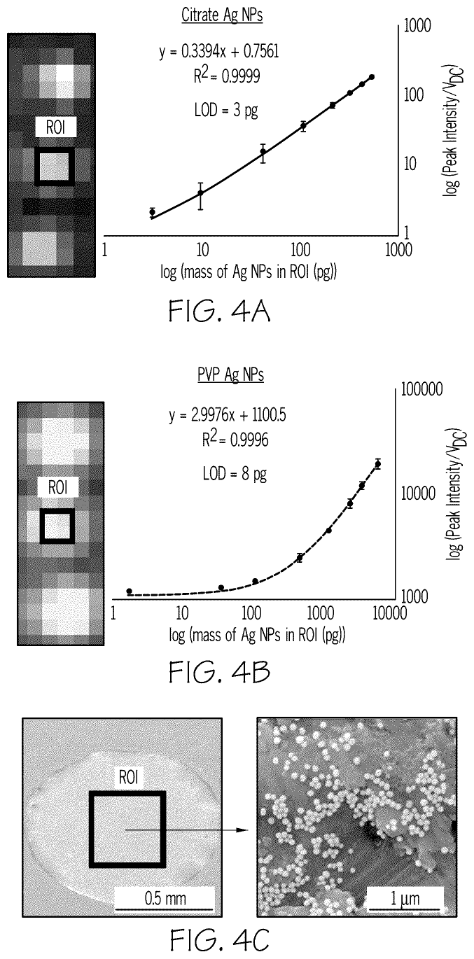

Quantitative figures-of-merit with the optimized conditions were obtained for Ag NPs with different surface functionalization, citrate vs PVP, from calibration curves (FIGS. 4A-4B). In this case, the ROI was restricted to the center of deposit (˜0.5 radius), enabled by the high GDOES EM spatial resolution achieved in this Example by operating at 30 Torr. The spatial resolution at 30 Torr was calculated using the line-spread function from the vertical edges of 3 deposits (6 edges) and was found to be between ˜130 μm and ˜160 μm. SEM of the ROI confirmed that no NP stacking was taking place, such that the sub-mono layer thickness is limited by the NP diameter. In addition, the PNC distribution obtained by SEM in the ROE allowed to use only the corresponding NP mass, instead of the NP mass of the whole deposit. Variations in the measured VDC between replicates was observed and was subsequently used to normalize the peak intensities of each image, which led to a significantly better linearity and reproducibility.

Applicant notes that the GD power pulse duration was set to 50 μs for citrate Ag NPs, while it was 125 μs for PVP Ag NPs. The longer pulse duration improved reproducibility but resulted in higher background intensity, which is reflected as a curvature in the linear function towards the lower masses (FIGS. 4A-4C) due to displaying the data on a log scale and having a nonzero y-intercept. Nevertheless, comparable LODs were obtained for 40 nm citrate Ag NPs (3±0.01 pg or 2.4 pg/μL, FIG. 4A) and 50 nm PVP Ag NPs (8±0.04 μg or 6.4 μg/μL, FIG. 4B). This is due in great part to using the measured ROI mass for calibration, which allows to account for differences in PNC distribution between citrate and PVP (c.f. FIG. 3L and FIG. 4C), which was significantly higher for PVP in the ROI. The mass LODs can be put into perspective by considering a study monitoring the uptake of 50 nm citrate Ag NPs into mouse neuroblastoma single-cells by laser ablation ICP-MS, which reported an average mass uptake of 81±67 μg/cell and LODs of 157 μg/μL40. Thus, the GDOES EM Ag NP LODs shown here are appropriate for single-cell uptake studies, with the caveat that these LODs were demonstrated on standard Ag NP solutions, and single-cell matrix effects are yet to be investigated.

When 25 ng of AgNO₃ (5×0.25 μL @ 20 ng/μL) was analyzed using the same method as the PVP Ag NPs, no Ag signal was observed. However, when 25 ng of AgNO₃ was added to 25 ng of Ag NPs, the signal was seen to increase ˜21% in comparison to the NP suspension by itself. This can be explained by the NPs allowing more efficient plasma coupling into the sample through the previously mentioned PCE. Nevertheless, concentrations of ionic Ag found in environmental water systems (rivers, lakes, and estuaries) are on the order of ˜10-100 ng/L, which are 5-6 orders-of-magnitude lower than what was measured in this Example. Thus, ion contributions to the total signal will not be significant.

### Example 1.12. Nanoparticle Size Characterization

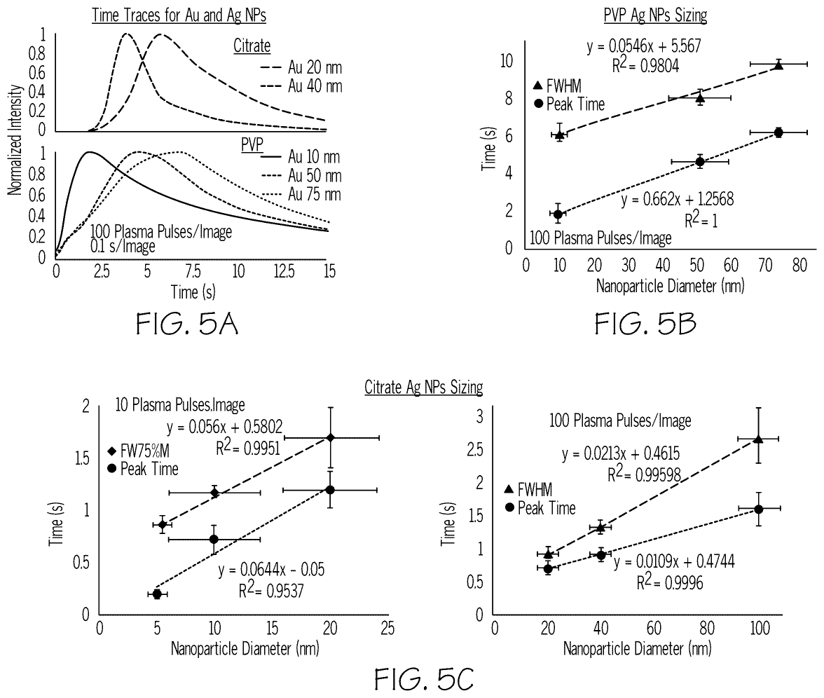

Next, the ability to perform NP size characterization via GDOES EM was also studied. The emission time profiles show that the peak intensity occurs at a later time and the full width at half maximum (FWHM) becomes wider as the NP in the deposit is increased in the range of 10 to 100 nm (FIGS. 5A-5C). Both effects show a linear relationship, even with different NP surface functionalization, which is greatly due to the sub-monolayer thickness corresponding to the NP. Decreasing x 10 the number of plasma pulses accumulated per image allowed the time resolution necessary to lower the NP range to 5 to 20 nm (FIG. 5C). In this case, the full width at 75% of the maximum (FW 75% M) had to be used because of the emission time profile tailing. The FWHM/FW 75% M and peak time NP deposit analytical sensitivities generally improve for larger deposits.

To Applicant's knowledge, this is the first time GDOES, in any operation mode, is demonstrated for characterization of NP size. Differentiation of Au NPs with deposits of ˜20 nm vs ˜40 nm, with sharper time-profile peaks and minimal tailing, demonstrates this technique is also applicable to various NP compositions (FIG. 5A). It is noteworthy that the FWHM/Peak Times are different for the citrate vs PVP coated Ag NPs (cf. FIGS. 5B and 5C). Thus, it would indicate that these calibration curves are specific to a NPs surface coating, such that prior separation based on their functionalities would need to be implemented in order to use this method as is. Alternatively, a universal calibration curve could be achieved by removing the capping agents by simple washing/centrifugation, other chemical methods, or “soft” plasma cleaning, which is a unique possibility with GD as demonstrated for removal of organic surface contaminants.

### Example 1.13. Ag Core/Silica Shell Nanoparticle Characterization

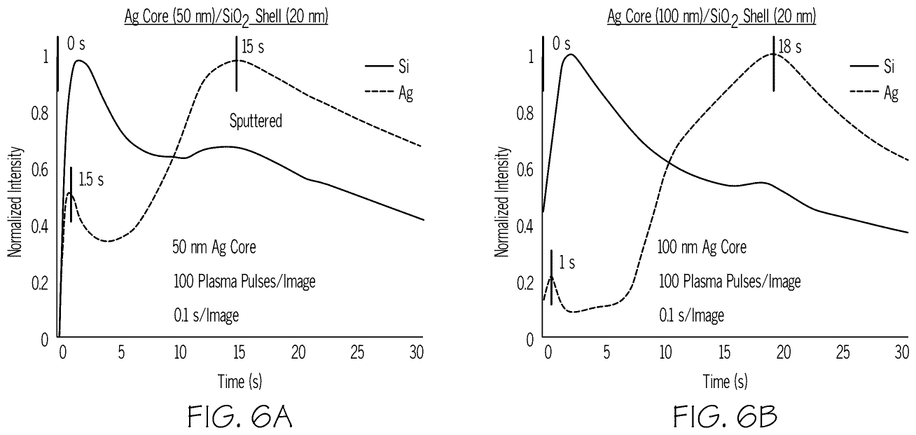

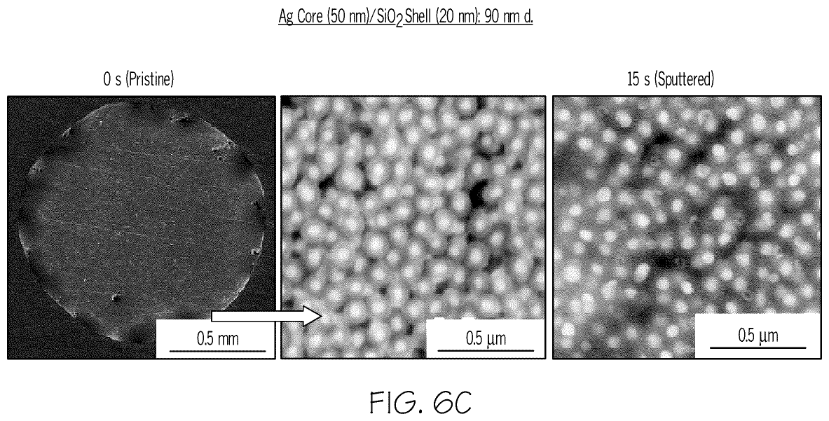

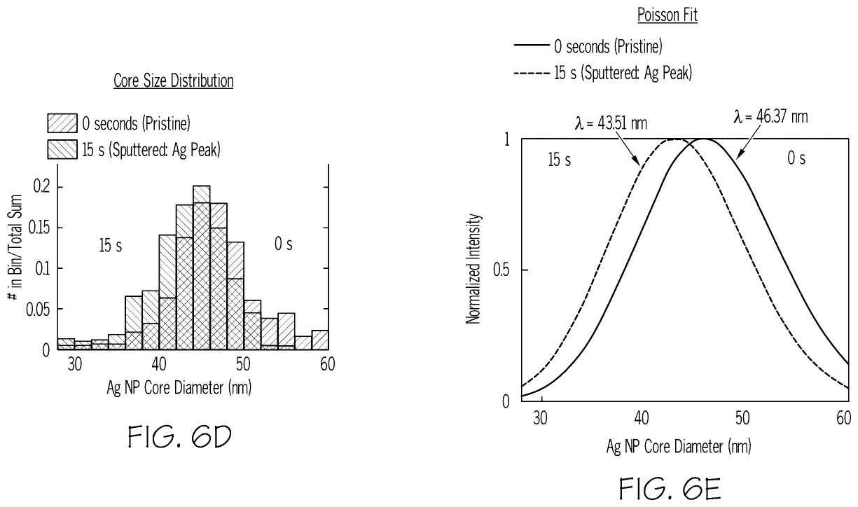

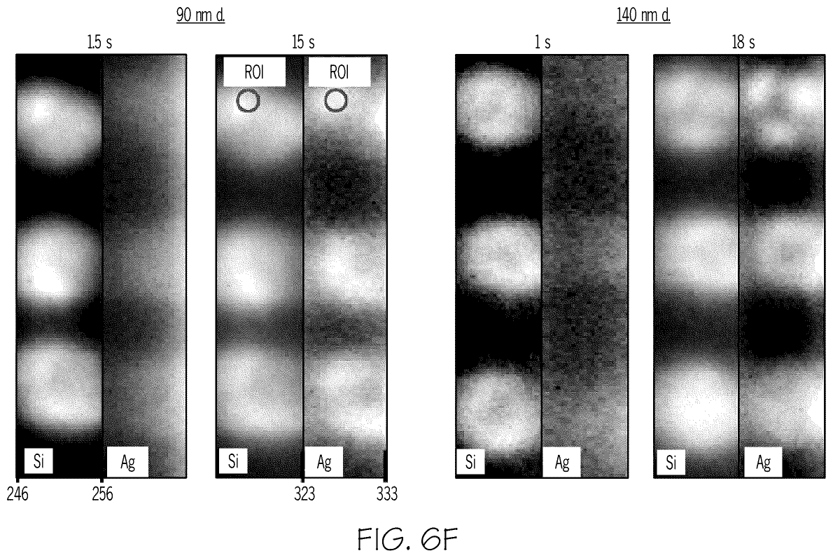

Finally, the capability of GDOES EM to characterize internal dimensions of complex NPs was also studied with Ag core/silica shell NPs. The emission time profiles for ˜90 nm total d. (x̅=47 nm, σ=5 nm core) and 140 nm total d. (x̅=92 nm, σ=12 nm core) show clear discrimination in peak time between the Si and Ag signals (FIGS. 6A-6B). It can be seen that the Si I signal peaks first at ˜2-3 s for both NP sizes, while the Ag I peaks later at 15 s for the 90 nm NPs or 18 s for the 140 nm particles. This shows that the silica shell is sputtered first before exposing the Ag core, which is consistent with a layer-by-layer sputtering process. This allows the ROI to be located at the edge of the deposit NP agglomerating on top of each other.

The SEM images of the core/shell NP sample sputtered to the Ag I peak show smaller core sizes compared to the ones in the pristine sample. Some NPs in the sputtered sample SEM also appear hollow, which is believed to be due to the high sputtering rate differences between SiO₂ and Ag. Once the core has been exposed to the plasma, the Ag may be sputtered away more rapidly while the silica shell remains and acts to block core edges from incoming sputtering species. The core size distribution histogram (FIG. 6D) shows the overall core size shifts to smaller d., as confirmed by Poisson fits (FIG. 6E), giving a lambda=46.37 nm/standard deviation=6.8 for the pristine sample, and lambda=43.51 nm/standard deviation=6.6 for the sputtered sample. The pristine sample SEM measured core d. are in good agreement with the manufacturers' specifications of 47±5 nm, which was measured via TEM.

In this Example, the larger spectral window used to measure Si I and Ag I simultaneously has lower spectral resolution. Thus, background subtraction is less efficient, particularly for the Ag I lines with N2 bands in the vicinity, and results in artifacts on its time-profile shape, such as the residual initial peak at ˜1s (FIGS. 6A-6B). The GDOES EM images (FIG. 6F) at the corresponding background residual peak in FIG. 6A (1.5 s) and FIG. 6B (1 s) show only molecular interferences at adjacent wavelengths overlapping the Ag wavelength. In addition, there are no characteristic spatial features indicative of emission from the NPs deposit, such as in the GDOES EM images at the Ag I peak time for 90 nm (15 s) and 140 nm (18 s) core-shell particle sizes.

On the other hand, sputtering rates and plasma impedance matching vary between material “layers”, and here, the impedance matching settings were kept constant throughout the measurement. Thus, the second peak in the Si I time profile, which coincides with Ag I, may be a result of improved impedance matching/sputtering rate as the Ag core is exposed.

### Example 1.14. Summary

In summary, this is the first time GDOES, in any operation mode, has been demonstrated for the successful discrimination of NP sizes and their elemental composition. GDOES EM enables significantly faster (data collection within seconds) NP characterization, with information about their spatial distribution over relatively large area samples, in comparison to traditional techniques. Furthermore, GDOES EM is also shown to give access to core/shell NPs composition and structure dimensions. It is worth noting that size determinations are not constrained by single particle mass detection limits. Moreover, this technique requires very fast and simple sample preparation without specialized equipment.

In addition, the technique presented in this Example opens the door for developing many different applications in several fields, such as cell NP uptake studies down to the single cell, analysis of NPs in micro-array platforms for even orders-of magnitude higher throughput analysis, and coupling with relevant NP separation techniques (e.g. gel electrophoresis and thin layer chromatography) for more comprehensive characterization.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of identifying one or more characteristics of particles, said method comprising:
placing the particles on a surface;
exposing the particles to an ion to result in emissions from the particles;
measuring the emissions from the particles;
generating an emission profile from the measured emissions; and
correlating the generated emission profile to one or more characteristics of the particles.

2. The method of claim 1, wherein the particles comprise nanoparticles.

3. The method of claim 1, wherein the surface is a component of a chamber of a glow discharge optical emission spectroscopy elemental mapping (GDOES EM) device.

4. The method of claim 1, wherein the exposure of the particles to the ion gradually ablates particle layers to result in emissions from different layers of the particles.

5. The method of claim 1, wherein the exposure of the particles to the ion occurs in a chamber of a glow discharge optical emission spectroscopy elemental mapping (GDOES EM) device.

6. The method of claim 1, wherein the ion comprises argon ion.

7. The method of claim 1, wherein the emissions from the particles are measured by glow discharge optical emission spectroscopy (GDOES).

8. The method of claim 1, wherein the emissions from the particles are measured continuously as a function of time.

9. The method of claim 1, wherein the generated emission profile represents emissions from the particles as a function of time.

10. The method of claim 1, wherein the generated emission profile comprises an emission pattern as a function of time, emission changes as a function of time, optical emission changes as a function of time, emission intensities as a function of time, emission peak intensity as a function of time, a peak delay time, an emission profile peak intensity time, an average pixel intensity, or combinations thereof.

11. The method of claim 1, wherein the one or more characteristics of the particles is selected from the group consisting of particle mass, particle elemental composition, particle size, particle shape, particle spatial distribution, or combinations thereof.

12. The method of claim 1, wherein the one or more characteristics of the particles comprise particle size.

13. The method of claim 1, wherein the one or more characteristics of the particles comprise particle elemental composition.

14. The method of claim 1, wherein the correlation of the generated emission profile to the one or more characteristics of the particles comprises comparing the generated emission profile from the particles to emission profiles of particles that have been correlated to the one or more characteristics of the particles.

15. The method of claim 1, wherein the correlation of the generated emission profile to the one or more characteristics of the particles comprises comparing the generated emission profile from the particles to a calibration curve that represents the one or more of the characteristics.

16. The method of claim 1, wherein the correlation of the generated emission profile to the one or more characteristics of the particles comprises feeding the generated emission profile from the particles into an algorithm that implements the correlation.

17. The method of claim 1, wherein the correlation of the generated emission profile to the one or more characteristics of the particles comprises at least one of correlating a peak delay time of the generated emission profile to particle size, correlating a peak delay time of the generated emission profile to particle size distribution, correlating a peak intensity of the generated emission profile to particle mass, correlating optical emission changes of the generated emission profile as a function of time to particle elemental composition, correlating optical emission changes of the generated emission profile as a function of time to particle size, correlating optical emission changes of the generated emission profile as a function of time to internal dimensions, or combinations thereof.
